(19) United States
(12) Patent Application Publication
(10) Pub. No.: US 2008/0219761 A1
(43) Pub. Date: Sep. 11, 2008

(54) Fastening Structure

(75) Inventors: Hitoshi Takamatsu, Aichi (JP); Masaki Yasuda, Aichi (JP)

Correspondence Address: ROBERTS MLOTKOWSKI SAFRAN & COLE, P.C., P. O. BOX 10064, MCLEAN, VA, 22102-8064, US

(73) Assignee: KABUSHIKI KAISHA TOKAI-RIKA-DENKI-SEISAKUSHO, Niwa-gun, Aichi (JP)

(21) Appl. No.: 11/718,392

(22) PCT Filed: Nov. 11, 2005
(86) PCT No.: PCT/JP05/21172

§ 371 Date: May 1, 2007

(30) Foreign Application Priority Data
Nov. 11, 2004 (JP) 2004-328115

(51) Int. Cl. F16B 5/06

(52) U.S. Cl. 403/338

(57) ABSTRACT

Cylindrical portions 34 are formed on a leg plate 20 side of plural opposition walls 32 formed on a sensor holder 24. Pins 40 are formed coaxially with the cylindrical portions 34 on the side of the opposition walls 32 opposite from the side facing the leg plate 20. When a sensor cover 44 is to be attached to the leg plate 20 in a state where the cylindrical portions 34 have been fittingly inserted into through holes 38 in the leg plate 20, cross ribs 56 formed on the sensor cover 44 in correspondence to the pins 40 push the pins 40 and cause them to enter the cylindrical portions 34. Thus, the diameters of the cylindrical portions 34 are expanded, whereby the sensor holder 24 is fastened/fixed to the leg plate 20.

### BACK GROUND OF THE INVENTION

1. Field of the Invention

The present invention relates to a fastening structure for fastening/fixing two mutually opposing members of three members that are to be attached to each other.

2. Description of the Related Art

A seat belt device that restrains the body of a passenger seated in the seat of a vehicle with a long band-like webbing belt is disposed with a webbing take-up device fixed to the vehicle body at the side of the seat. This type of webbing take-up device (webbing retractor) has a lock mechanism for reliably retaining the body of the passenger wearing the webbing belt when the vehicle undergoes a sudden deceleration. An example thereof is disclosed in Japanese Patent Application Publication (JP-A) No. 2003-212086.

When the vehicle undergoes a sudden deceleration, the lock mechanism causes a pawl disposed on one axial-direction end of a spool to mesh with a ratchet of inner teeth formed on the frame of the webbing take-up device. Thus, the rotation of the spool in the pullout direction, which is the rotational direction when the webbing belt is pulled out, is regulated. Consequently, the webbing is prevented from being pulled out from the spool.

Thus, even if the body of the passenger, which tries to inertially move toward the front side of the vehicle as a result of the sudden deceleration of the vehicle, pulls the webbing belt, the webbing belt is not pulled out from the spool. For this reason, the body of the passenger is reliably retained by the webbing belt worn on the body of the passenger, and the inertial movement of the passenger toward the front side of the vehicle can be regulated.

Incidentally, the lock mechanism is disposed with a case in order to house, or support at a predetermined position, a configuration for causing the pawl to move and a configuration for detecting the sudden deceleration of the vehicle. The case is fixed to the frame of the webbing take-up device in a state where the case houses the various members configuring the lock mechanism.

Ordinarily the case is formed by a synthetic resin material, and is divided into a plate positioned at the frame side and a cover that covers the plate from the opposite side of the frame via the plate.

Plug pins may used to attach the case with this structure to the frame. In a structure using plug pins, plural holes are formed in the frame, and cylindrical portions having open ends are formed on the frame in correspondence to these holes.

The cylindrical portions enter the holes in a state where the cylindrical portions are fastened/fixed to the plate. When the plug pins are inserted into the cylindrical portions, the plug pins push against the cylindrical portions from inside and cause the diameters of the cylindrical portions to expand, whereby they cause the outer peripheral portions of the cylindrical portions to push against the inner peripheral portions of the holes. Thus, the plate is fastened/fixed to the frame.

However, when the plug pins are configured by separate independent parts, there is the potential for some of the plural plug pins to not be inserted into the holes and give rise to poor fastening. Moreover, when the plate is covered with the cover, the fact that the plug pins are not inserted into the holes cannot be seen.

As one strategy for eliminating this drawback, it is conceivable to form the plug pins integrally with the cover so that the plug pins are inserted into the holes when the cover is attached to the plate or the frame.

However, in a configuration where the plug pins are formed on the cover in this manner, there is the potential for the plug pins to not be insertable into the holes if the positional precision of the cover with respect to the plate is not strictly set.

### SUMMARY OF THE INVENTION

In view of this circumstance, it is an object of the present invention provides a fastening structure that can reliably prevent poor fastening and fastening forgetting and in which the positional precision between the members does not have to be strictly set.

A first aspect of the invention provides a fastening structure for attaching and fastening an attached member disposed between a base member and a cover member to the base member, the fastening structure including: a hole portion that is formed in the base member and whose end portion at the cover member side is open; a cylindrical portion that is formed such that it protrudes from the surface of the attached member at the base member side in correspondence to the hole portion, is formed in a cylindrical shape such that the protrusion direction becomes its axial direction, and enters the corresponding hole portion in a state where the attached member is attached to the base member; a columnar portion that is coupled to the inner peripheral portion of the cylindrical portion, is formed such that it protrudes toward the side opposite from the base member, and is enterable into the cylindrical portion as a result of a portion coupling the columnar portion to the cylindrical portion being broken; and a push portion that is formed on the base member side of the cover member in correspondence to the columnar portion, the push portion faces the tip end of the columnar portion along the direction in which the cover member is attached to the base member or the attached member in a state where the cylindrical portion and the hole portion face each other along the axial direction of the cylindrical portion, contacts the tip end of the columnar portion when the cover member is attached to the base member or the attached member, and pushes the columnar portion toward the base member.

In the fastening structure of the first aspect, when the attached member is to be attached to the base member, the cylindrical portion formed on the attached member is inserted into the hole portion formed in the base member.

Next, the cover member approaches the base member from the side of the attached member opposite from the side facing the base member, and is attached to the base member or the attached member.

When the cover member is moved toward the attached member when the cover member is to be attached to the base member or the attached member as described above, the push portion formed on the cover member contacts the tip end of the columnar portion formed on the attached member and pushes the columnar portion. When the columnar portion is pushed by the push portion in this manner, the portion where the columnar portion is coupled to the inner peripheral portion of the cylindrical portion breaks, and the columnar portion enters the cylindrical portion. Thus, the attached member is fastened/fixed to the base member.

Here, in the fastening structure pertaining to the invention, because the columnar portion is coupled to the inner peripheral portion of the cylindrical portion, the columnar portion can be integrally formed with the attached member together with the cylindrical portion. Thus, when the attached member is to be attached to the base member, there is no forgetting to fittingly insert the columnar portion into the cylindrical portion.

A second aspect of the invention provides a fastening structure for attaching and fastening an attached member disposed between a base member and a cover member to the base member, the fastening structure including: a plurality of hole portions that are formed in the base member and whose end portions at the cover member side are open; a plurality of cylindrical portions that are formed such that they protrude from the surface of the attached member at the base member side in correspondence to the hole portions, are formed in cylindrical shapes such that the protrusion direction becomes their axial direction, and enter the corresponding hole portions in a state where the attached member is attached to the base member; a plurality of columnar portions that are coupled to the inner peripheral portions of the cylindrical portions, are formed such that they protrude toward the side opposite from the base member, and are enterable into the cylindrical portions as a result of portions coupling the columnar portion to the cylindrical portions being broken; and a plurality of push portions that are formed on the base member side of the cover member in correspondence to the columnar portions, the plurality of push portions respectively face the tip ends of the columnar portions along the direction in which the cover member is attached to the base member or the attached member in a state where the cylindrical portions and the hole portions face each other along the axial direction of the cylindrical portions, contact the tip ends of the columnar portions when the cover member is attached to the base member or the attached member, and push the columnar portions toward the base member.

In the fastening structure of the second aspect, when the attached member is to be attached to the base member, the plural cylindrical portions formed on the attached member are inserted into the plural hole portions formed in the base member.

Next, the cover member approaches the base member from the side of the attached member opposite from the side facing the base member, and is attached to the base member or the attached member.

When the cover member is moved toward the attached member when the cover member is to be attached to the base member or the attached member as described above, the plural push portions formed on the cover member contact the tip ends of the columnar portions formed on the attached member and push the columnar portions. When the columnar portions are pushed by the push portions in this manner, the portions where the columnar portions are coupled to the inner peripheral portions of the cylindrical portions break, and the columnar portions enter the cylindrical portions. Thus, the attached member is fastened/fixed to the base member.

Here, in the fastening structure pertaining to the invention, because the columnar portions are coupled to the inner peripheral portions of the cylindrical portions, the columnar portions can be integrally formed with the attached member together with the cylindrical portions. Thus, when the attached member is to be attached to the base member, there is no forgetting to fittingly insert the columnar portions into the cylindrical portions.

Also, the tip ends of the plural columnar portions are pushed by the plural push portions formed on the cover member, whereby the columnar portions are inserted into the corresponding cylindrical portions. Thus, all of the plural columnar portions can be inserted into the corresponding cylindrical portions at once.

Moreover, the insertion amount of the columnar portions in the cylindrical portions is determined by how much the columnar portions are pushed by the push portions. The pushing amount of the push portions (i.e., how much the columnar portions are pushed by all of the push portions) can be set in advance by forming the push portions on the cover member to be attached to the attached member or the base member. Thus, all of the columnar portions can be fittingly inserted into the cylindrical portions uniformly.

Moreover, because the columnar portions are coupled to the inner peripheral portions of the cylindrical portions, the columnar portions can be reliably fittingly inserted into the cylindrical portions by pushing the tip ends of the columnar portions and breaking the portions where they are coupled to the cylindrical portions. Thus, the positional precision of the attachment of the cover member with respect to the attached member does not have to be strictly set in comparison to the configuration where the columnar portions are formed on the cover member, for example.

As described above, the fastening structure pertaining to the invention can reliably prevent poor fastening resulting from forgetting to insert the columnar portions into the hole portions. Moreover, the attached member can be fastened/fixed to the base member by inserting the columnar portions into the hole portions, even if the positional precision between the members is not strictly set.

### BRIEF DESCRIPTION OF THE DRAWING

FIG. 1 is an exploded perspective view showing the configuration of relevant portions of a webbing take-up device applying a fastening structure pertaining to an embodiment of the invention.

FIG. 2 is an enlarged cross-sectional view showing a portion where cylindrical portions and columnar portions are formed on an attached member.

FIG. 3 is a cross-sectional view showing a state where the cylindrical portions are inserted into hole portions.

FIG. 4 is a cross-sectional view corresponding to FIG. 3 showing a state where push portions push the columnar portions into the cylindrical portions.

FIG. 5 is a cross-sectional view showing a modified example of the cylindrical portions.

### DESCRIPTION OF THE PREFERRED EMBODIMENT

### Configuration of the Embodiment

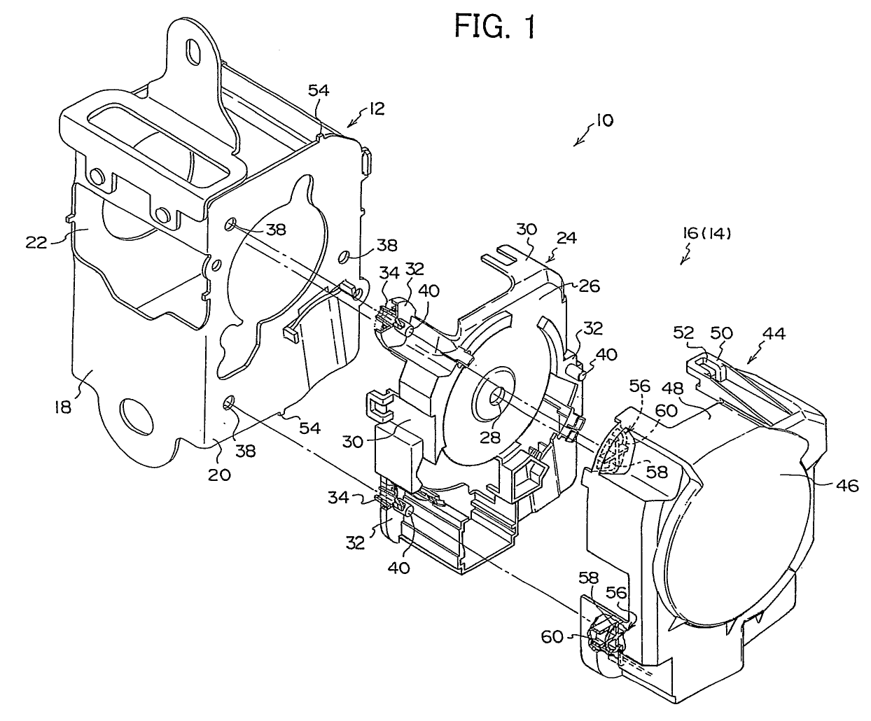

In FIG. 1, an exemplary configuration where a fastening structure pertaining to an embodiment of the invention is applied to the attachment of a frame 12 serving as a base member of a webbing take-up device 10 and a case 16 of a lock mechanism 14 is shown in exploded perspective view.

As shown in this drawing, the frame 12 is disposed with a plate-like back plate 18 whose thickness direction is along the substantial left-right direction of the vehicle. The back plate 18 is fixed with a bolt or the like to the vehicle body in the vicinity of the lower end portion of a center pillar, for example, whereby the webbing take-up device 10 is attached to the vehicle body.

A pair of leg plates 20 and 22 is formed such that they bend inward in the vehicle width direction (substantial left-right direction of the vehicle) from one width-direction end of the back plate 18 along the substantial front-rear direction of the vehicle in a state of attachment to the vehicle. A spool to which a base end portion of a long band-like webbing belt is attached (neither of which is shown) is disposed between the leg plate 20 and the leg plate 22. The spool is rotated in a take-up direction, which is one direction around its axis, due to the urging force of urging means such as a spiral coil spring, whereby the webbing belt is taken up and accommodated around the spool from its base end side.

A sensor holder 24 serving as an attached member configuring the case 16 of the lock mechanism 14 is disposed at the side of the leg plate 20 opposite from the side facing the leg plate 22. The sensor holder 24 is disposed with a bottom plate 26.

The bottom plate 26 is formed in a plate-like shape that is substantially parallel to the leg plate 20. A through hole 28 is formed in the bottom plate 26, and one end of the spool and one end of a torsion shaft disposed coaxially and integrally with the spool penetrate the through hole 28. A vertical wall 30 is formed on the outer peripheral portion of the bottom plate 26. The vertical wall 30 is cut out at a predetermined site, such that part of a pretensioner (not shown) disposed between the bottom plate 26 and the leg plate 20 passes through the cutout portion.

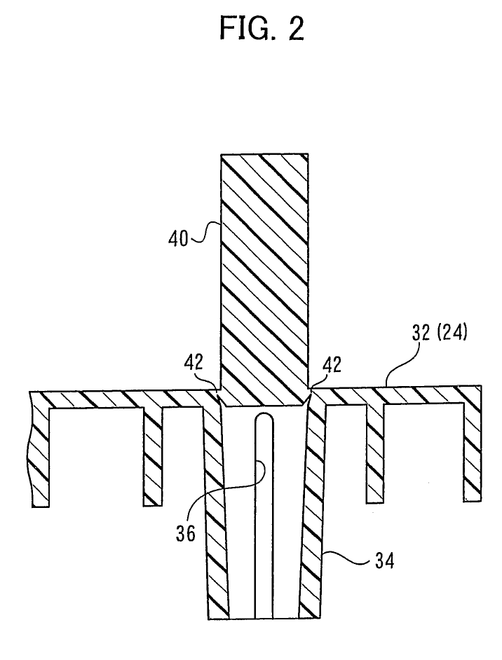

Plural opposition walls 32 are formed on the end portion of the vertical wall 30 opposite from the bottom plate 26. The opposition walls 32 are formed in plate-like shapes parallel to the bottom plate 26 and the leg plate 20. As shown in FIG. 1, and in detail in FIG. 2, cylindrical portions 34 that have substantially circular cylinder-like shapes are formed on the leg plate 20 side of the opposition walls 32. The axial-direction base end portions of the cylindrical portions 34 are coupled to the opposition walls 32, and the tip end sides are open with the opposition walls 32 serving as bottom portions.

Also, as shown in FIG. 2, the inner periphery of each cylindrical portion 34 is tapered such that the inner diameter dimension gradually becomes smaller from the base end portion to the tip end portion. Moreover, a pair of cutout portions 36 is formed in each cylindrical portion 34. The pair of cutout portions 36 is formed such that they are open at the inner peripheral portion, the outer peripheral portion and the tip end portion of the cylindrical portion 34, and such that they face each other around the axial center portion of the cylindrical portion 34.

Plural through holes 38 serving as hole portions are formed in the leg plate 20 in correspondence to the cylindrical portions 34. The inner diameter dimension of the through holes 38 is slightly larger than the outer diameter dimension of the cylindrical portions 34, such that the cylindrical portions 34 can be fittingly inserted inside the through holes 38 from their tip end sides.

Pins 40 serving as columnar portions are formed such that they protrude from the surfaces of the opposition walls 32 opposite from the surfaces disposed with the cylindrical portions 34. The pins 40 have substantially circular column-like shapes and are formed coaxially with respect to the cylindrical portions 34. The pins 40 are formed such that their outer diameter dimension is slightly smaller than the inner diameter dimension of the base end portions of the cylindrical portions 34 and slightly larger than the inner diameter dimension of the tip end portions of the cylindrical portions 34.

Moreover, the portions where the outer peripheral portions of the base end portions of the pins 40 are connected to the opposition walls 32 serve as fragile portions 42. The fragile portions 42 are formed annularly along the outer peripheral portions of the pins 40, and are thinner and have a weaker mechanical (physical) strength than the other portion of the opposition walls 32.

As shown in FIG. 1, a sensor cover 44 serving as a cover member is disposed at the side of the sensor holder 24 opposite from the side facing the leg plate 20. The members configuring the lock mechanism 14 are housed and disposed inside a space enclosed by the sensor cover 44 and the bottom plate 26 of the sensor holder 24.

The sensor cover 44 is disposed with a bottom wall 46 that is substantially parallel to the bottom plate 26. A peripheral wall 48 protrudes toward the sensor holder 24 from the outer peripheral portion of the bottom wall 46. The peripheral wall 48 is formed in a size such that it can house the bottom plate 26 of the sensor holder 24.

Fitting pieces 50 are formed at predetermined sites on the tip end (the bottom plate 26 side end portion opposite) of the peripheral wall 48. A through hole 52 that penetrates the thickness direction of the fitting pieces 50 is formed in each fitting piece 50.

Fitting protrusions 54 are formed such that they protrude from the outer peripheral portion of the leg plate 20 in correspondence to the fitting pieces 50. The fitting protrusions 54 enter the through holes 52 in the fitting pieces 50, whereby the sensor cover 44 is fitted/fixed to the leg plate 20.

Cross ribs 56 serving as push portions are formed at predetermined sites on the tip end of the peripheral wall 48 in correspondence to the plural opposition walls 32. Each cross rib 56 is configured by a vertical wall 58 and a horizontal wall 60, and the direction in which the bottom plate 26 and the bottom wall 46 face each other corresponds to the width direction of the cross ribs 56. When seen in the thickness direction of the bottom wall 46, the horizontal walls 60 are orthogonal to the vertical walls 58 in cross-like shapes.

The portions where the vertical walls 58 and the horizontal walls 60 intersect each other are disposed such that they basically face the axial centers of the pins 40 along the direction in which the bottom plate 26 and the bottom wall 46 face each other. As for the end portions of the cross ribs 56 at the sensor holder 24 side, the width dimensions of the vertical walls 58 and the horizontal walls 60, and the protrusion dimension of the pins 40, are generally set such that when any one of the cross ribs 56 contacts the tip end of the corresponding pin 40 in a state where the bottom wall 46 of the sensor cover 44 is substantially parallel to the bottom plate 26 of the sensor holder 24, the other cross ribs 56 contact the tip ends of the facing pins 40.

The positions of the cross ribs 56 along the depth direction when the sensor cover 44 is regarded as a box-like shape opening toward the sensor holder 24 are set such that the end portions of the cross ribs 56 at the sensor holder 24 side contact, or are slightly separated from, the opposition walls 32 in a state where the fitting protrusions 54 have entered the through holes 52 in the fitting pieces 50.

### Action and Effects of the Present Embodiment

Next, the action and effects of the present embodiment will be described by describing the procedure of attaching the sensor holder 24 and the sensor cover 44 to the leg plate 20.

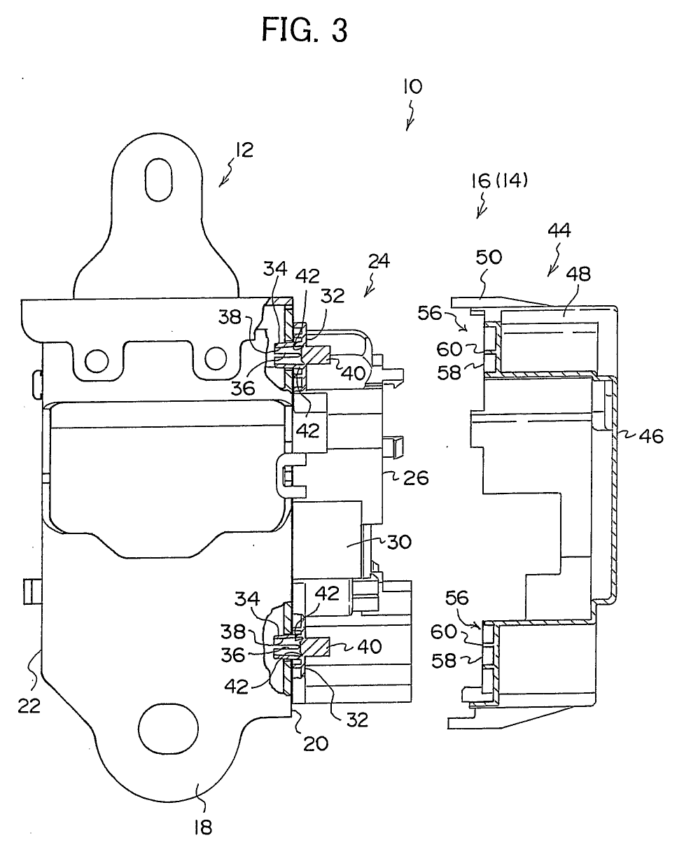

When the sensor holder 24 and the sensor cover 44 are to be attached to the leg plate 20, first, as shown in FIG. 3, the cylindrical portions 34 of the sensor holder 24 are fittingly inserted into the corresponding through holes 38 from their tip end portions.

Next, from this state, the sensor cover 44 is moved toward the side of the sensor holder 24 opposite from the side facing the leg plate 20 in a state where the bottom wall 46 of the sensor cover 44 and the bottom plate 26 of the sensor holder 24 are substantially parallel. Thus, first, the tip ends of the fitting pieces 50 of the sensor cover 44 strike (contact) the fitting protrusions 54. When the sensor cover 44 is further moved toward the leg plate 20 in this striking (contacting) state, the fitting pieces 50 elastically deform and bypass the fitting protrusions 54.

When the fitting pieces 50 run over the fitting protrusions 54, and when the through holes 52 and the fitting protrusions 54 face each other, the fitting pieces 50 return to their state before deformation due to elasticity, and the fitting protrusions 54 enter the through holes 52. Thus, the sensor cover 44 is fitted/fixed to the leg plate 20.

Also, when the sensor cover 44 is moved toward the leg plate 20 in a state where the bottom wall 46 and the bottom plate 26 are substantially parallel as described above, the end portions of all of the cross ribs 56 at the leg plate 20 side contact the tip ends of the corresponding pins 40. When the sensor cover 44 is further moved toward the leg plate 20 in this state, all of the cross ribs 56 push the corresponding pins 40 toward the leg plate 20, and the fragile portions 42 are broken by the pushing force. Thus, all of the pins 40 become independent from the sensor holder 24.

When the sensor cover 44 is further moved toward the leg plate 20 in this state, the cross ribs 56 cause the pins 40 to enter the cylindrical portions 34. Because the inner diameter dimension of the tip end sides of the cylindrical portions 34 is smaller than the outer diameter dimension of the pins 40 as described above, the pins 40 push the cylindrical portions 34 from inside when the pins 40 reach the tip end sides of the cylindrical portions 34.

Moreover, because the pair of cutout portions 36 is formed in each of the cylindrical portions 34 as described above, the cylindrical portions 34 are pushed from inside by the pins 40, whereby the cylindrical portions 34 are pushed and expanded around the pair of cutout portions 36. Thus, the outer diameter dimension of the cylindrical portions 34 is expanded.

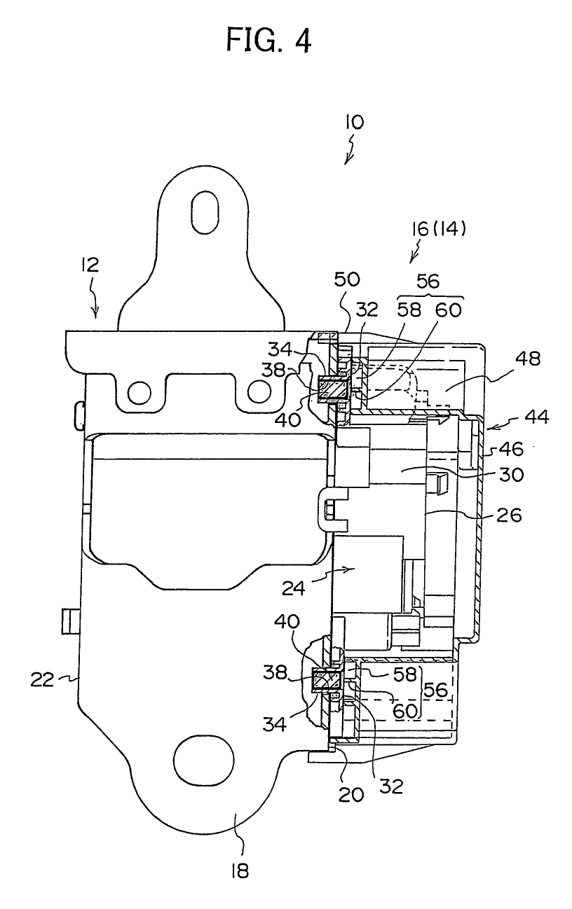

Because the outer diameter dimension of the cylindrical portions 34 is expanded in this manner, as shown in FIG. 4, the outer peripheral portions of the cylindrical portions 34 push against the inner peripheral portions of the through holes 38, and the sensor holder 24 is fastened/fixed to the leg plate 20.

In the present embodiment, where the sensor holder 24 and the sensor cover 44 are attached to the leg plate 20 as described above, the pins 40 are coupled to the opposition walls 32 (facing walls), and therefore the inner peripheral portions of the cylindrical portions 34, via the fragile portions 42. For this reason, the pins 40 can be integrally formed with the sensor holder 24 together with the cylindrical portions 34. Thus, when the sensor holder 24 is to be attached to the leg plate 20, there is no forgetting to fittingly insert the pins 40 into the cylindrical portions 34.

Also, because the tip ends of the plural pins 40 are pushed by the plural cross ribs 56 formed on the sensor cover 44, the pins 44 are fittingly inserted into the corresponding cylindrical portions 34. Thus, all of the plural pins 40 can be fittingly inserted into the corresponding cylindrical portions 34 at one time.

Moreover, the insertion amount of the pins 40 in the cylindrical portions 34 is determined by how much the pins 40 are pushed by the cross ribs 56, i.e., by the positions of the pins 40 and the cross ribs 56 along the direction in which the bottom plate 26 and the bottom wall 46 face each other. The pushing amount of the pins 40 (i.e., how much the pins 40 are pushed) by all of the cross ribs 56 can be set in advance by forming the cross ribs 56 on the sensor cover 44 to be attached to the leg plate 20. Thus, all of the pins 40 can be fittingly inserted into the cylindrical portions 34 uniformly.

Moreover, the pins 40 are predisposed coaxially with the cylindrical portions 34 and coupled to the opposition walls 32, and therefore the inner peripheral portions of the cylindrical portions 34, via the fragile portions 42. For this reason, the pins 40 can be reliably fittingly inserted into the cylindrical portions 34 as a result of the fragile portions 42 being broken by the pushing force from the cross ribs 56. Thus, the positional precision of the attachment of the sensor cover 44 with respect to the sensor holder 24 does not have to be strictly set in comparison to the configuration where the pins 44 are formed on the sensor cover 44, for example.

In the present embodiment, the cylindrical portions 34 were pushed and expanded by the pins 40 inserted into the cylindrical portions 34, and the outer peripheral portions of the cylindrical portions 34 were pushed against the inner peripheral portions of the through holes 38, whereby the sensor holder 24 was fastened/fixed to the leg plate 20. However, the present invention is not limited to the configuration where the outer peripheral portions of the cylindrical portions 34 are pushed against the inner peripheral portions of the through holes 38.

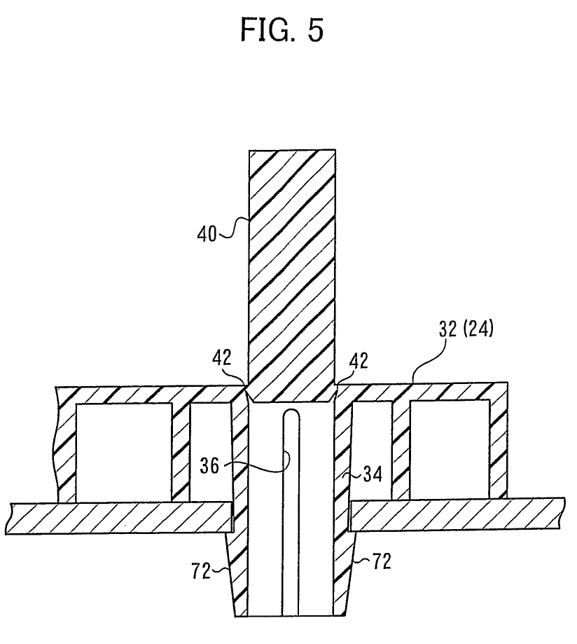

For example, as shown in FIG. 5, the invention may also be configured such that pawl portions 72, which can engage (mesh) with the leg plate 20 from the side opposite from the side facing the bottom plate 26 in a state where the cylindrical portions 34 have penetrated the through holes 38, are formed on the outer peripheral portions of the cylindrical portions 34, with the inner diameter dimension of the cylindrical portions 34 being made substantially the same as the outer diameter dimension of the pins 40 along the axial direction.

In this configuration, when the cylindrical portions 34 are to be passed through the through holes 38, the cylindrical portions 34 penetrate the through holes 28 while the cylindrical portions 34 are elastically deformed such that their diameters are reduced. Next, when the pins 40 are fittingly inserted into the cylindrical portions 34 in this state, the diameters of the cylindrical portions 34 are not expanded by the pins 40, but the deformation of the cylindrical portions 34, like the diameters of the cylindrical portions 34 being reduced, is regulated by the pins 40.

For this reason, the state of facing (meshing) between the pawl portions 72 and the leg plate 20 along the axial direction of the cylindrical portions 34 is not eliminated, and if the cylindrical portions 34 try to escape from the through hole 28, the pawl portions 72 reliably interfere (mesh) with the leg plate 20 and the movement in the direction in which the cylindrical portions 34 escape from the through hole 28 is reliably regulated.

In the present embodiment, the fastening structure pertaining to the invention was applied to the attachment of the sensor holder 24 and the sensor cover 44 with respect to the frame 12 of the webbing take-up device 10. However, the present invention is not limited to the attachment of the sensor holder 24 and the sensor cover 44 with respect to the frame 12 of the webbing take-up device 10. The fastening structure pertaining to the invention is a structure that can be widely used in order to fasten/fix two mutually opposing members of three members that are to be attached to each other, and is not limited to the specific applied examples described in the present embodiment.

1. A fastening structure for attaching and fastening an attached member disposed between a base member and a cover member to the base member, the fastening structure comprising:
a hole portion that is formed in the base member and whose end portion at the cover member side is open;
a cylindrical portion that is formed such that it protrudes from the surface of the attached member at the base member side in correspondence to the hole portion, is formed in a cylindrical shape such that the protrusion direction becomes its axial direction, and enters the corresponding hole portion in a state where the attached member is attached to the base member;
a columnar portion that is coupled to the inner peripheral portion of the cylindrical portion, is formed such that it protrudes toward a side opposite to the base member, and is enterable into the cylindrical portion as a result of a portion coupling the columnar portion to the cylindrical portion being broken; and
a push portion that is formed on the base member side of the cover member in correspondence to the columnar portion, wherein the push portion faces the tip end of the columnar portion along the direction in which the cover member is attached to the base member or the attached member in a state where the cylindrical portion and the hole portion face each other along the axial direction of the cylindrical portion, contacts the tip end of the columnar portion when the cover member is attached to the base member or the attached member, and pushes the columnar portion toward the base member,
wherein the columnar portion enters into the cylindrical portion, due to the columnar portion being pushed by the push portion of the cover member, in a state where the attached member is attached to the base member.

2. The fastening structure of claim 1, comprising at least one set of the hole portion, the cylindrical portion, the columnar portion and the push portion.

3. The fastening structure of claim 1, comprising a plurality of set of the hole portion, the cylindrical portion, the columnar portion and the push portion.

4. The fastening structure of claim 1, wherein the inner periphery of the cylindrical portion is formed in a tapered shape whose inner diameter dimension gradually becomes smaller from the base end portion to the tip end portion.

5. The fastening structure of claim 1, wherein the cylindrical portion comprises a cutout portion that opens at the inner peripheral portion, outer peripheral portion and tip end portion of the cylindrical portion.

6. The fastening structure of claim 1, wherein the cylindrical portion comprises a pawl portion on its outer peripheral portion, and when the cylindrical portion enters the hole portion, the pawl portion meshes with the base member from the side opposite from the insertion side.

7. A fastening structure for attaching and fastening an attached member disposed between a base member and a cover member to the base member, the fastening structure comprising:
a plurality of hole portions that are formed in the base member and whose end portions at the cover member side are open;
a plurality of cylindrical portions that are formed such that they protrude from the surface of the attached member at the base member side in correspondence to the hole portions, are formed in cylindrical shapes such that the protrusion direction becomes their axial direction, and enter the corresponding hole portions in a state where the attached member is attached to the base member;
a plurality of columnar portions that are coupled to the inner peripheral portions of the cylindrical portions, are formed such that they protrude toward a side opposite to the base member, and are enterable into the cylindrical portions as a result of portions coupling the columnar portions to the cylindrical portions being broken; and
a plurality of push portions that are formed on the base member side of the cover member in correspondence to the columnar portions, wherein the plurality of push portions respectively face the tip ends of the columnar portions along the direction in which the cover member is attached to the base member or the attached member in a state where the cylindrical portions and the hole portions face each other along the axial direction of the cylindrical portions, contact the tip ends of the columnar portions when the cover member is attached to the base member or the attached member, and push the columnar portions toward the base member,
wherein the columnar portion enters into the cylindrical portion, due to the columnar portions being pushed by the push portions of the cover member, in a state where the attached member is attached to the base member.

8. The fastening structure of claim 7, wherein the inner periphery of each of the cylindrical portion is formed in a tapered shape whose inner diameter dimension gradually becomes smaller from the base end portion to the tip end portion.

9. The fastening structure of claim 7, wherein each of the cylindrical portions comprises a cutout portion that opens at the inner peripheral portion, outer peripheral portion and tip end portion of the cylindrical portion.

10. The fastening structure of claim 7, wherein each of the cylindrical portions comprises a pawl portion on its outer peripheral portion, and when the cylindrical portions enter the hole portions, the pawl portions mesh with the base member from the side opposite from the insertion side.
